(19) United States
(12) Patent Application Publication
(10) Pub. No.: US 2010/0177095 A1
(43) Pub. Date: Jul. 15, 2010

(54) GEOSPATIAL MODELING SYSTEM FOR REDUCING SHADOWS AND OTHER OBSCURATION ARTIFACTS AND RELATED METHODS

(75) Inventors: WILLIAM WATKINS, Melbourne Beach, FL (US); MARK RAHMES, Melbourne, FL (US); JOSEF ALLEN, Melbourne, FL (US); RONALD A. RILEY, West Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 12/353,388

(22) Filed: Jan. 14, 2009

(51) Int. Cl. G06T 15/60; G06K 9/40

(52) U.S. Cl. 345/426; 382/274; 382/100

(57) ABSTRACT

A geospatial modeling system may include a geospatial model database having stored therein an initial three-dimensional (3D) model of a geographical area, and an initial image for the geographical area. The initial image may have actual shadow portions. The geospatial modeling system may also include a processor cooperating with the geospatial model database and configured to generate estimated shadow portions for the initial 3D model, generate a shadow difference between the estimated shadow portions and the actual shadow portions, and reduce the actual shadow portions of the initial image based upon the shadow difference to generate a corrected image.

### FIELD OF THE INVENTION

The present invention relates to the field of geospatial modeling, and, more particularly, to geospatial modeling of imagery with shadows and related methods.

### BACKGROUND OF THE INVENTION

In certain applications, detailed imagery of large and expansive surfaces may be needed. These applications may include geographic satellite mapping, for example, where imagery of portions of the Earth's surface are gathered via satellite. A typical approach for displaying the expansive data in these applications is a mosaic image. The typical mosaic image may be formed by several smaller sized images. Before production of the mosaic image, each of the smaller images is typically registered between each other to determine their relative position.

A typical problem encountered in mosaic images is shadowing of the subject geographical area. For example, in optical satellite imagery, the data collected is based upon reflected light from the sun. In applications where the geographical area includes significant urban development, for example, high rise buildings, etc., the mosaic image may include significant shadow portions where the return data is less than desirable,

Since the typical application of optical satellite imagery may be expansive and include a large number of images, there are several automated approaches to detecting shadow portions in the images for subsequent compensation. For example, the shadows may be detected using edge finding techniques, contrast detection techniques, heuristic based techniques, and statistical techniques that use background estimation based upon decomposition of color changes.

Typical approaches to compensating for detected shadow portions in applications of optical satellite imagery may include, for example, manual approaches where the user adjusts shadowed portions of the image using image manipulation software, and wholesale adjustment of image brightness and contrast. A potential drawback to some of these approaches is that they may affect the data of the entire image, i.e. they change portions of the image that are not shadowed.

An approach to shadow removal is disclosed in the article “A System of the Shadow Detection and Shadow Removal for High Resolution City Aerial Photo” by Li et al., incorporated herein by reference in its entirety. This approach includes detecting a shadow portion in the optical satellite image. Once the shadow portion has been detected, the method includes determining a companion portion that is not part of the shadow portion but is neighboring to the shadow portion. The method includes determining the return data statistics of the companion area, and mapping the return data statistics onto the corresponding shadow portion.

Another approach to compensating for shadow portions in optical satellite imagery is disclosed in U.S. Patent Application Publication No. 2005/0212794 to Furukawa et al., the entire contents of which are incorporated herein by reference. This approach includes calculating a direction of the sun in a coordinate system having a three-dimensional (3D) geometrical model having an object therein, and detecting a shadow region cast on the 3D geometrical model by a beam from the sun so as to identify the shadow region in the image data. The approach uses a predetermined reflection model to estimate effects of shadings caused in the 3D geometrical model and determines a parameter of a reflection model suited to estimate shadings. The approach also includes performing calculations for removing the effects of the shadows by using the determined parameter from pixel values sampled from the image data so as to fit the calculated pixel values in the 3D geometrical model and generate a texture model.

### SUMMARY OF THE INVENTION

In view of the foregoing background, it is therefore an object of the present invention to provide a geospatial modeling system that reduces shadow in imagery, such as optical imagery.

This and other objects, features, and advantages in accordance with the present invention are provided by a geospatial modeling system comprising a geospatial model database having stored therein an initial three-dimensional (3D) model of a geographical area, and at least one initial image for the geographical area. The initial image may have actual shadow portions. The geospatial modeling system may also include a processor cooperating with the geospatial model database and configured to generate estimated shadow portions for the initial 3D model, generate a shadow difference between the estimated shadow portions and the actual shadow portions, and reduce the actual shadow portions of the initial image based upon the shadow difference to generate at least one corrected image. Advantageously, the actual shadow portions of the initial image are accurately enhanced using the initial 3D model.

More specifically, the processor may further be configured to reduce the actual shadow portions by at least updating the initial 3D model based upon the shadow difference, generating at least one estimated image based upon the updated 3D model and corresponding to the initial image, and reducing the actual shadow portions of the initial image based upon the estimated image. For example, the processor may be configured to update the initial 3D model by at least using gain compensation calculations.

Additionally, the processor may be configured to reduce the actual shadow portions by at least adding data in the initial image from the initial 3D model. Furthermore, the geospatial model database may also store collection geometry data associated with the initial image. The processor may also be configured to generate the estimated shadow portions based upon geometric ray projection calculations with the collection geometry data.

In some embodiments, the geospatial modeling system may further comprise a display coupled to the processor for displaying the corrected image. More particularly, the initial 3D model may comprise at least one of a digital surface model (DSM), a light detection and ranging (LIDAR) model, a Shuttle Radar Topography Mission (SRTM) model, and a synthetic-aperture radar (SAR) model, for example. Also, the initial image may, for example, comprise a two-dimensional (2D) aerial earth image or an electric optical (EO) image.

Another aspect is directed to a computer implemented method for using an initial 3D model of a geographical area to generate at least one corrected image of at least one initial image having actual shadow portions. The method may include generating estimated shadow portions for the initial 3D model, generating a shadow difference between the estimated shadow portions and the actual shadow portions, and reducing the actual shadow portions of the at least one initial image based upon the shadow difference to generate at least one corrected image.

### BRIEF DESCRIPTION OF THE DRAWINGS

FIG. 1 is a schematic diagram of a geospatial modeling system according to the present invention.

FIG. 2 is a more detailed schematic diagram of the geospatial modeling system of FIG. 1.

FIG. 3 is a flowchart illustrating a computer implemented method for geospatial modeling according to the present invention.

FIG. 4 is an image of the estimated shadow portions in the geospatial modeling system of FIGS. 1 and 2.

FIGS. 5 and 6 are images of the estimated shadow portions as a function of ambience in the geospatial modeling system of FIGS. 1 and 2.

FIG. 7 is a schematic block diagram of a geospatial modeling system according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

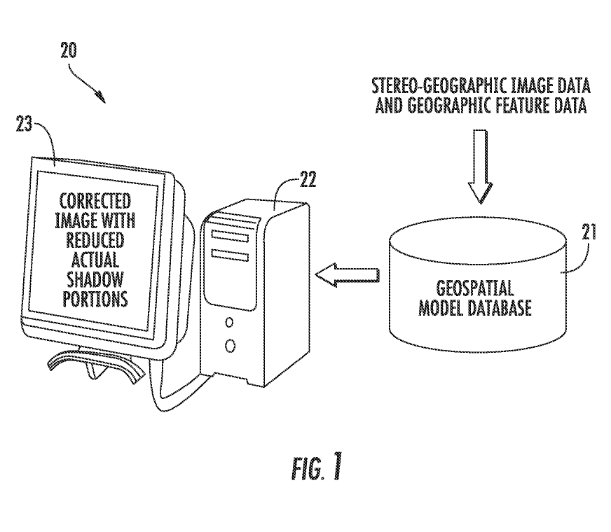

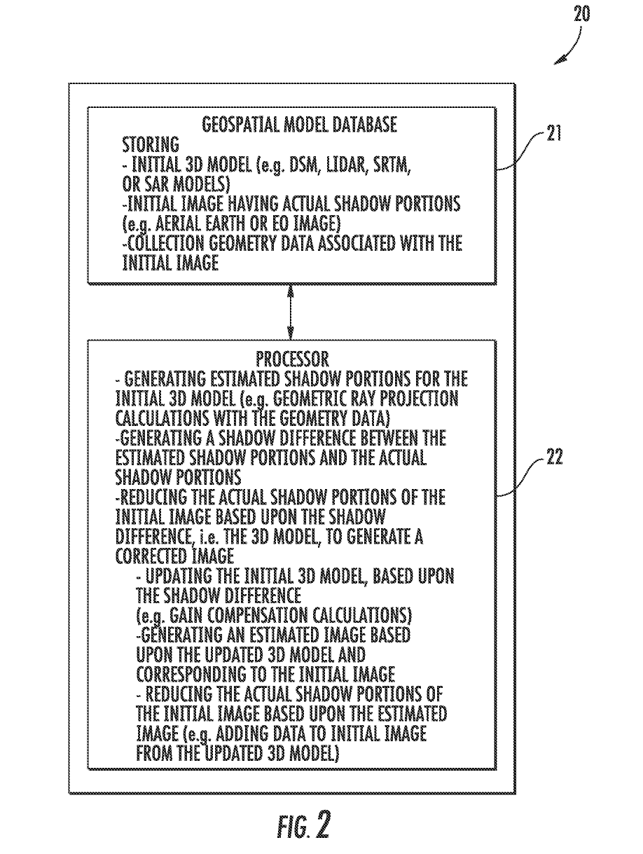

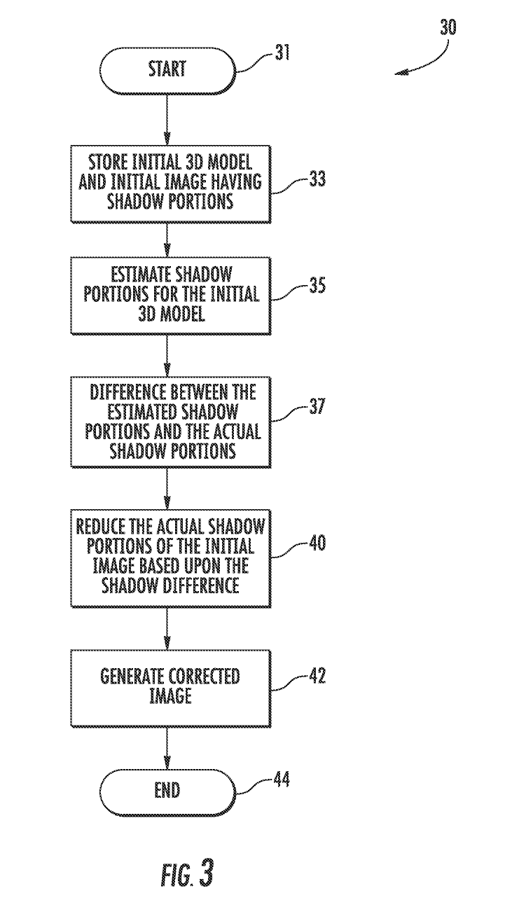

Referring initially to FIGS. 1-3, a geospatial modeling system 20 according to the present invention is now described. Moreover, with reference to the flowchart 30 of FIG. 3, another aspect directed to a computer implemented method for geospatial modeling is also now described, which begins at Block 31. The geospatial modeling system 20 illustratively includes a geospatial model database 21, a processor 22, illustrated as a personal computer (FIG. 1), coupled thereto, and a display 23 also coupled to the processor 22. By way of example, the processor 22 may be a central processing unit (CPU) of a PC, Mac, or other computing workstation.

The geospatial model database 21 illustratively stores at Block 33 an initial three-dimensional (3D) model of a geographical area, and at least one initial image for the geographical area. More particularly, the initial 3D model may comprise at least one of a digital surface model (DSM), a light detection and ranging (LIDAR) model, a Shuttle Radar Topography Mission (SRTM) model, and a synthetic-aperture radar (SAR) model, for example.

In other embodiments, the geospatial model database may also store data relating to the physical properties of the surface of 3D objects in the initial 3D model regarding the sensing technology, i.e. propensity to get return data, for example. That is, in these embodiments, the 3D model is an effective four-dimensional model and could include more than four-dimensions if desired. In embodiments using the DSM for the initial 3D model, the processor 22 may generate the initial DSM using the method disclosed in U.S. Patent Application Publication No. 2007/0265781 to Nemethy et al., also assigned to the assignee of the present invention, and the entire contents of which are incorporated by reference herein.

Also, the at least one initial image may, for example, comprise a two-dimensional (2D) aerial earth image, an electric optical (EO) image, and/or an optical satellite image. In certain embodiments, the at least one initial image may comprise a plurality thereof defining a mosaic image. The initial image has actual shadow portions. As will be appreciated by those skilled in the art, the actual shadow portions may include areas where the return data is less than desirable for the applied sensor technology. The actual shadow portions may be detected using manual or automatic approaches, for example, edge detection. The geospatial model database 21 also illustratively stores collection geometry data associated with the initial image, for example, geolocation data and collection platform telemetry data.

The processor 22 illustratively cooperates with the geospatial model database 21 at Block 35 for generating estimated shadow portions for the initial 3D model. For example, the processor 22 may cooperate with the geospatial model database 21 to generate the estimated shadow portions based upon geometric ray projection calculations with the collection geometry data, i.e. ray tracing and the like. As will be appreciated by those skilled in the art, shadows on a 3D model surface from visibility of the illuminating sun may be calculated. The 3D model is rendered as a “minimum-range” image from the perspective of the sun with roughly half the separation of points on the model surface (or twice the resolution) relative to the EO image being compared to the model. Points on the model surface farther from the sun than the minimum in the image are not visible to the sun and are in shadow. By computing the range image at a higher resolution than the EO image, this binary visibility image can be integrated over a pixel area to provide the fraction of each EO pixel in shadow.

The processor 22 illustratively cooperates with the geospatial model database 21 at Block 37 for generating a shadow difference between the estimated shadow portions and the actual shadow portions. The estimated shadow portions will approximate the true shadows in the initial image. Nonetheless, the estimated shadow portions will not be a perfect match due to the limited accuracy and resolution of the current 3D model. Using the estimated shadow as an initial segmentation of shadow/non-shadow of the initial image, those skilled in the art can apply various methods to refine the shadow/non-shadow classification of the initial image.

The processor 22 illustratively cooperates with the geospatial model database 21 at Block 40 for reducing the actual shadow portions and other obscuration artifacts of the initial image based upon the shadow difference to generate at Block 42 at least one corrected image. The processor 21 may then provide the corrected image on the display 23 for the user. More specifically, the processor 22 reduces the actual shadow portions by at least updating the initial 3D model based upon the shadow difference, for example, by using gain compensation calculations. Once the true shadow mask has been obtained from the initial image, the 3D model is modified by finding the minimal increase in elevation for the modeled shadow to agree with the true shadows. As appreciated by those skilled in the art, a number of methods may be applied for adjusting the gain and offsets of the shadow regions based on a full atmospheric illumination model, or in-painting based on other imagery collected without shadows due to different illumination resulting from collection at a different time of day.

The processor 22 also generates at least one estimated image based upon the updated 3D model and corresponding to the initial image. In other words, the processor 22 uses the updated 3D model to provide a synthetic image with greatly reduced or no shadow portions that correspond to the initial image, which has the actual shadow portions.

The processor 22 further reduces the actual shadow portions of the initial image based upon the estimated image. In other words, the processor 22 adds data in the initial image from the initial 3D model. Advantageously, the actual shadow portions of the initial image are accurately enhanced, i.e. shadows filled-in or reduced, using the initial 3D model. The processor 22 ends the method at Block 44.

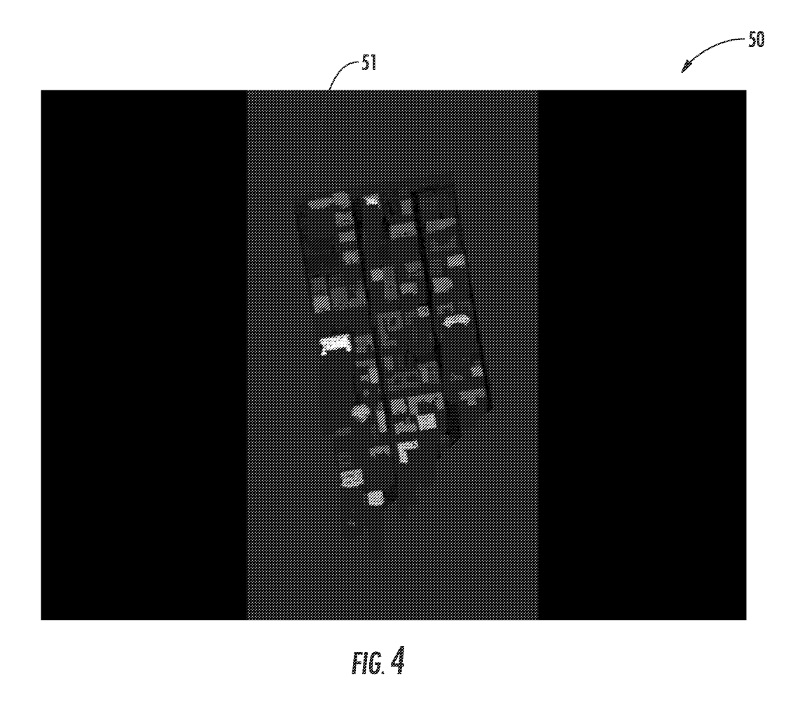

Referring now additionally to FIG. 4, an image 50 illustrates estimated shadow portions for the initial 3D model as generated in the geospatial modeling system 20 described herein. The estimated shadow portions are generated based upon features in the initial 3D model, for example, the illustrated structures 51. As will be appreciated by those skilled in the art, the geospatial modeling system 20 generates estimated shadows as a function of the sun's position in the sky. More specifically, for optical imagery, the estimated shadow portions are generated with an estimated sun position that corresponds to the sun position in the initial image.

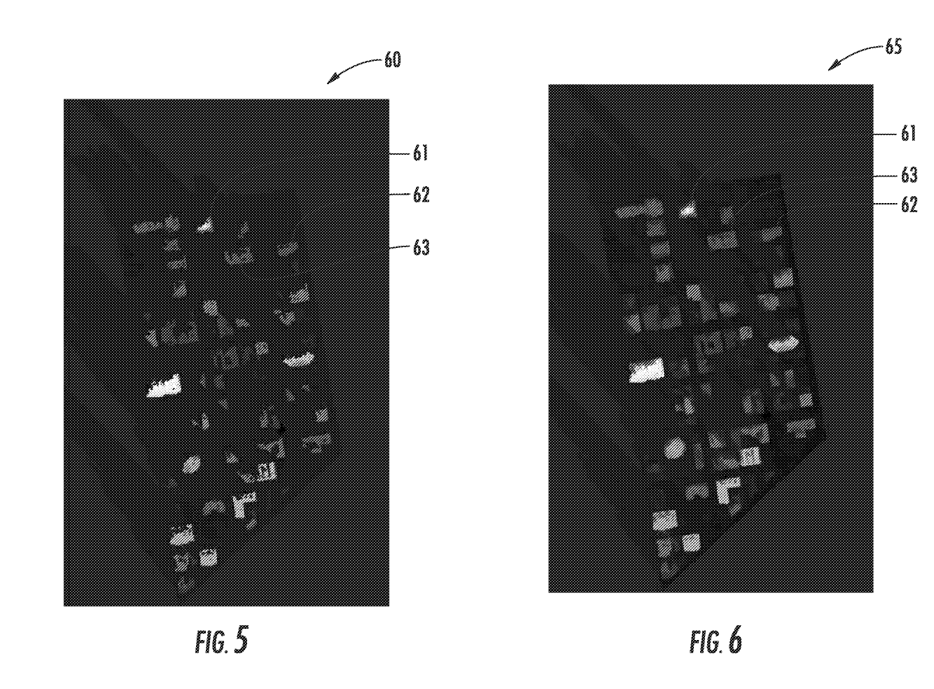

Referring now additionally to FIGS. 5 and 6, images 60, 65 again illustrate estimated shadow portions for the initial 3D model as generated in the geospatial modeling system 20 described herein. More specifically, the images 60, 65 have respective ambience values of 0 percent and 75 percent respectively, i.e. the ambience comprising the amount of scattered light from the sky. The first image 60 represents an ambience value of 0 percent, which is total obscuration, whereas the second image 65 represents an ambience value of 75 percent, which is partial obscuration. The shadows are generated based upon features in the initial 3D model, for example, the illustrated structures 61-63.

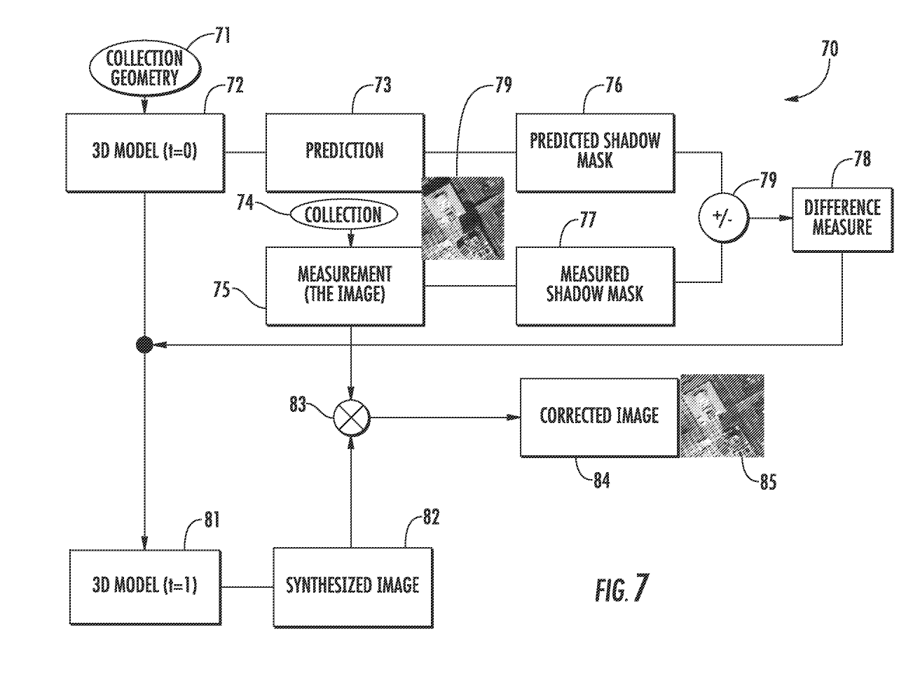

Referring additionally to FIG. 7, as will be appreciated by those skilled in the art, an exemplary implementation 70 of the geospatial modeling system 20 is now further described. The exemplary implementation 70 of the geospatial modeling system illustratively ingests the collection geometry 71 at a 3D model module 72 and ingests the collection 74 of images 79 at a measurement module 75. The exemplary implementation 70 of the geospatial modeling system illustratively includes a prediction module 73 downstream from the 3D module 72 for predicting the shadows based upon the initial 3D model. The exemplary implementation 70 of the geospatial modeling system illustratively includes a predicted shadow module 76 downstream from the prediction module 73 for providing the predicted shadow mask based upon the initial 3D model.

The exemplary implementation 70 of the geospatial modeling system illustratively includes a measured shadow mask module 77 downstream from the measurement module 75 for determining the shadow in the initial image, and a difference block 79 downstream from the predicted shadow module 76 and the measured shadow mask module 77 for differencing the measured shadow in the initial image and the predicted shadow mask. The difference is provided at the difference measure module 78. The exemplary implementation 70 of the geospatial modeling system illustratively includes an updated 3D model module 81 downstream from the difference block 79 for providing an updated 3D model based upon the difference in shadow, and a synthetic image module 82 downstream from the updated 3D model module 81 for providing a corresponding synthetic image based upon the updated 3D model. The exemplary implementation 70 of the geospatial modeling system illustratively includes a mixer block 83 downstream from the synthetic image module 82 and the measurement module 15 for combining the initial image and the synthetic image, and a corrected image module 84 downstream from the mixer block for providing a corrected image 85.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A geospatial modeling system comprising:
a geospatial model database having stored therein an initial three-dimensional (3D) model of a geographical area, and at least one initial image for the geographical area, the at least one initial image having actual shadow portions; and
a processor cooperating with said geospatial model database and configured to
generate estimated shadow portions for the initial 3D model,
generate a shadow difference between the estimated shadow portions and the actual shadow portions, and
reduce the actual shadow portions of the at least one initial image based upon the shadow difference to generate at least one corrected image.

2. The geospatial modeling system according to claim 1 wherein said processor is further configured to reduce the actual shadow portions by at least:
updating the initial 3D model based upon the shadow difference;
generating at least one estimated image based upon the updated 3D model and corresponding to the at least one initial image; and
reducing the actual shadow portions of the at least one initial image based upon the at least one estimated image.

3. The geospatial modeling system according to claim 2 wherein said processor is further configured to update the initial 3D model by at least using gain compensation calculations.

4. The geospatial modeling system according to claim 1 wherein said processor is further configured to reduce the actual shadow portions by at least adding data in the at least one initial image from the initial 3D model.

5. The geospatial modeling system according to claim 1 wherein said geospatial model database also stores collection geometry data associated with the at least one initial image; and wherein said processor is further configured to generate the estimated shadow portions based upon geometric ray projection calculations with the collection geometry data.

6. The geospatial modeling system according to claim 1 further comprising a display coupled to said processor for displaying the at least one corrected image.

7. The geospatial modeling system according to claim 1 wherein the initial 3D model comprises at least one of a digital surface model (DSM), a light detection and ranging (LIDAR) model, a Shuttle Radar Topography Mission (SRTM) model, and a synthetic-aperture radar (SAR) model.

8. The geospatial modeling system according to claim 1 wherein the at least one initial image comprises a two-dimensional (2D) aerial earth image.

9. The geospatial modeling system according to claim 1 wherein the at least one initial image comprises an electric optical (EO) image.

10. A geospatial modeling system comprising:
a geospatial model database having stored therein an initial three-dimensional (3D) model of a geographical area, at least one initial image for the geographical area, the at least one initial image having actual shadow portions, and collection geometry data associated with the at least one initial image;
a processor cooperating with said geospatial model database and configured to
generate estimated shadow portions for the initial 3D model based upon geometric ray projection calculations with the collection geometry data,
generate a shadow difference between the estimated shadow portions and the actual shadow portions, and
reduce the actual shadow portions of the at least one initial image based upon the shadow difference to generate at least one corrected image; and
a display coupled to said processor for displaying the at least one corrected image.

11. The geospatial modeling system according to claim 10 wherein said processor is further configured to reduce the actual shadow portions by at least:
updating the initial 3D model based upon the shadow difference;
generating at least one estimated image based upon the updated 3D model and corresponding to the at least one initial image; and
reducing the actual shadow portions of the at least one initial image based upon the at least one estimated image.

12. The geospatial modeling system according to claim 11 wherein said processor is further configured to update the initial 3D model by at least using gain compensation calculations.

13. The geospatial modeling system according to claim 10 wherein said processor is further configured to reduce the actual shadow portions by at least adding data in the at least one initial image from the initial 3D model.

14. The geospatial modeling system according to claim 10 wherein the initial 3D model comprises at least one of a digital surface model (DSM), a light detection and ranging (LIDAR) model, a Shuttle Radar Topography Mission (SRTM) model, and a synthetic-aperture radar (SAR) model.

15. A computer implemented method for using an initial three-dimensional (3D) model of a geographical area to generate at least one corrected image of at least one initial image having actual shadow portions, the method comprising:
generating estimated shadow portions for the initial 3D model;
generating a shadow difference between the estimated shadow portions and the actual shadow portions; and
reducing the actual shadow portions of the at least one initial image based upon the shadow difference to generate the at least one corrected image.

16. The computer implemented method according to claim 15 wherein reducing the actual shadow portions comprises:
updating the initial 3D model based upon the shadow difference;
generating at least one estimated image based upon the updated 3D model and corresponding to the at least one initial image; and
reducing the actual shadow portions of the at least one initial image based upon the at least one estimated image.

17. The computer implemented method according to claim 16 wherein updating the initial 3D model comprises using gain compensation calculations.

18. The computer implemented method according to claim 15 wherein reducing the actual shadow portions comprises adding data in the at least one initial image from the initial 3D model.

19. The computer implemented method according to claim 15 wherein generating the estimated shadow portions is based upon geometric ray projection calculations with collection geometry data associated with the at least one initial image.

20. The computer implemented method according to claim 15 further comprising displaying the at least one corrected image.
